(19) United States
(12) Patent Application Publication
(10) Pub. No.: US 2024/0079548 A1
(43) Pub. Date: Mar. 7, 2024

(54) METHOD FOR THE MANUFACTURE OF ELECTRODES

(71) Applicants: Solvay SA, Brussels (BE); COMMISSARIAT A L' ENERGIE ATOMIQUE ET AUX ENERGIES ALTERNATIVES, Paris (FR)

(72) Inventors: Dominique Bascour, Grez-Doiceau (BE); Marc-David Braida, Bry-Sur-Marne (FR); Ludovic Odoni, Rillieux-La-Pape (FR); Julio A Abusleme, Varese (IT); Hélène Rouault, Le Versoud (FR); Gaëlle Besnard, Grenoble (FR); Léo Merchat, Grenoble (FR); Jérémie Salomon, Villard-De-Lans (FR); Benjamin Amestoy, Grenoble (FR)

(73) Assignees: Solvay SA, Brussels (BE); Commissariat A L'Energie Atomique Et Aux Energies Alternatives, Paris (FR)

(21) Appl. No.: 18/260,874

(22) PCT Filed: Dec. 27, 2021
(86) PCT No.: PCT/EP2021/087668

§ 371 Date: Jul. 10, 2023

(30) Foreign Application Priority Data
Jan. 8, 2021 (EP) 21305021.4

(51) Int. Cl. H01M 4/04; H01M 4/139; H01M 4/62

(52) U.S. Cl. CPC H01M 4/0411; H01M 4/0433; H01M 4/0435; H01M 4/139; H01M 4/623

(57) ABSTRACT

The present invention pertains to a continuous process for the manufacture of an electrode, to the electrode obtained therefrom and to an electrochemical device comprising said electrode.

### CROSS-REFERENCE TO RELATED APPLICATIONS

This application claims priority to European application No. 21305021.4 filed on Jan. 8, 2021, the whole content of this application being incorporated herein by reference for all purposes.

### TECHNICAL FIELD

The present invention pertains to a continuous process for the manufacture of an electrode, to the electrode obtained therefrom and to an electrochemical device comprising said electrode.

### BACKGROUND ART

To date, techniques for manufacturing either positive or negative electrodes or lithium batteries involve the use of organic solvents such as N-methyl-2-pyrrolidone (also referred to as “NMP”) for dissolving fluoropolymer binders and homogenizing them with an electro-active material and all other suitable components to produce a paste to be applied to a metal current collector.

The role of the organic solvent is typically to dissolve the fluoropolymer in order to bind the electro-active material particles to each together and to the metal current collector upon evaporation of the organic solvent. The polymer binder should properly bind the electro-active material particles together and to the metal collector so that these particles can chemically withstand large volume expansion and contraction during charging and discharging cycles.

Although NMP is a solvent widely used for dissolving fluoropolymers, its use of NMP is raising issues from both human health and environmental impact perspective.

Furthermore, in the preparation of thick electrodes the presence of high content of solvents may damage the electrode itself during evaporation of said solvent leading to cracks formation.

Thus, the development of lithium batteries needs to find more sustainable and less costly manufacturing processes, and the first requirement is to reduce or better to eliminate the solvent, used in the process for the preparation of the electrode.

Therefore, recently the need was felt for alternative processes for the manufacture of electrodes in the absence of solvents.

For example, Seeba et. Al. Chemical Engineering Journal 402 (2020) 125551 discloses an extrusion-based coating process for producing electrodes wherein an electrode-forming composition with a substantially reduced amount of solvent is used. Good results on coin cells are obtained and no substantial differences in terms of electrochemical performance are appreciated between electrodes obtained by a solvent casting process and the reduced-solvent extrusion process.

WO 2020/225041 discloses the preparation of electrodes by extrusion of an electrode paste comprising no solvent for the fluorinated polymer binder on aluminum or copper, followed by a step of redistributing the paste on the metal by means of a press at high temperature to produce uniform electrodes.

There is still a need of a continuous or semi continuous process that provides an electrode ready to be assembled in the battery with high electrochemical performance and in the absence of solvents for dissolving the binder, hence no recycle is needed.

### SUMMARY OF INVENTION

The Applicant surprisingly found that the above technical problem can be solved by the process according to the present invention.

Thus, in a first aspect, the present invention relates to a process for the manufacture of an assembly, said process comprising:
(i) providing a surface-modified metal foil (M) having at least one side that is at least partially chemically modified;
(ii) providing an electrode-forming composition [composition (C)] comprising:
from 0.5 wt. % to less than 20 wt. %, preferably to less than 15 wt. % of at least one semi-crystalline partially fluorinated polymer [polymer (F)] comprising recurring units derived from 1,1-difluoroethylene (VDF);
from 2 wt. % to less than 40 wt. % of at least one liquid medium [medium (L)] characterized by a boiling point higher than 100° C., preferably higher than 125° C., more preferably higher than 150° C., wherein said medium (L) may optionally further comprise at least one metal salt [salt (M)];
at least 50 wt. % of at least one electro-active compound [compound (EA)];
optionally, a polymer [polymer (P)] comprising a backbone complying with the following formula:

—[(CH₂)ₓ—CHR¹—R²)—
wherein
x is in integer from 1 to 3,
R¹ is hydrogen or methyl group; and
R² is oxygen atom or a group of formula —OC(═O)R³ with R³ being hydrogen atom or methyl.
wherein the above amounts are based on the total weight of said composition (C);
(iii) mixing said composition (C) in a mixing device at a temperature lower than 50° C.;
(iv) extruding the mixed composition (C) obtained in step (iii) through a die opening at temperature comprised between 50 and 130° C. to provide a sheet of composition (C);
(v) optionally, laminating the sheet of composition (C) obtained in step (iv) to provide a sheet having a thickness in the range of from 50 to 300 microns;
(vi) depositing the sheet of composition (C) obtained in step (iv) or in step (v) onto at least one side of the surface-modified metal foil (M) provided in step (i), thereby providing an assembly comprising a surface-modified metal foil (F) having at least part of at least one side that is coated with a layer (L1) consisting of said composition (C).

In another aspect, the present invention relates to an assembly obtained with the above-mentioned process. Advantageously, said assembly comprises:
at least one surface-modified metal foil (M), and
directly adhered onto at least one side of said surface-modified metal foil (M), at least one layer (L1) consisting of a composition (C) as defined above.

Advantageously, said assembly is an electrode [electrode (E)]. More preferably, said electrode (E) is a positive electrode [electrode (Ep)] or a negative electrode [electrode (En)].

The electrode (E) of the invention is particularly suitable for use in electrochemical devices.

Non-limiting examples of suitable electrochemical devices include secondary batteries, preferably alkaline or alkaline-earth secondary batteries. More preferably, said secondary battery is a lithium secondary battery.

### DESCRIPTION OF EMBODIMENTS

As used within the present description and in the following claims, the use of parentheses around symbols or numbers identifying the formulae, for example in expressions like “polymer (P)”, etc., has the mere purpose of better distinguishing the symbol or number from the rest of the text and, hence, said parenthesis can also be omitted.

The surface-modified metal foil (M) suitable for use in the process of the present invention is a metal foil having two sides with at least one side that is at least partially chemically modified.

The at least one side of the metal foil (M) can suitably be at least partly modified by means of any surface treatment that allows the formation of a surface layer (SL).

The nature of the surface layer (SL) depends on the metal foil to be modified and on the surface treatment applied on the metal foil (M).

Surface treatments suitable for forming the surface layer (SL) comprise any surface treatments selected from the group consisting of chemical modification, chemical etching, electrochemical etching, electrodeposition, chemically oxidized processes, coating, corona discharge.

Chemical modifications, chemical and electrochemical etching, electrodeposition, chemically oxidized processes, coating and corona discharge, are other commonly used surface treatments for obtaining a surface layer (SL) on metal foils (M) for use in the process of the present invention.

Chemical etching can effectively roughen the surface of current collectors, which is favourable for improving adhesion and interfacial conductivity between electrodes and current collectors.

Chemical modification can suitably be obtained by treatment with chemicals such as acids.

Coating is another effective way to modify the surface of a metal foil (M) to achieve better performance in terms of enhanced electronic conductivity, adhesion towards the electrode and reduction of the corrosion. Reducing the corrosion is expected to improve the general performance of the battery by improving the good contact with the paste of the electrode by improving the electronic conductivity.

Suitable coating treatments include coating the surface with compositions comprising a binder and particles selected from the group consisting of conductive carbons, graphites, graphenes, carbon nanotubes, activated carbon fibers, non-activated carbon nanofibers, metal flakes, powders metal, metal fibers, metal oxides and electrically conductive polymers. Preferred coating compositions are those comprising particles selected from the group consisting of carbons, graphites, graphenes, carbon nanotubes, activated carbon fibers, non-activated carbon nanofibers.

The average thickness of the surface layer (SL) of the surface of the metal foil (M) suitable for the process of the present invention is preferably in the range from 0.5 nm to 50 μm. Such a thickness can be determined by standard characterization methods like AFM (atomic force microscopy) and SEM (scanning electron microscope).

The thickness of the surface layer (SL) greatly depends on the surface treatment that is applied onto the metal foil surface.

In the present invention, the nature of the metal foil to be used as current collector depends on whether the electrode thereby provided is a positive electrode or a negative electrode. Should the electrode of the invention be a positive electrode, the metal foil to be modified typically comprises, preferably consists of, at least one metal selected from the group consisting of Aluminium (Al), Nickel (Ni), Titanium (Ti), and alloys thereof, preferably Al. Should the electrode of the invention be a negative electrode, the metal foil to be modified typically comprises, preferably consists of, Silicon (Si) or at least one metal selected from the group consisting of Lithium (Li), Sodium (Na), Zinc (Zn), Magnesium (Mg), Copper (Cu) and alloys thereof, preferably Cu.

Suitable modification of the surface layer of metal foil to obtain surface-modified metal foil (M) for use in the present invention are those disclosed for example by:
CARBON 52 (2013) 128-136, regarding the formation of a graphene oxide layer;
J. Mater. Chem. A, 2016, 4, 395, describing a chromate conversion coating method;
Int. J. Electrochem. Sci., 10 (2015) 2324-2335, regarding oxides from Al and Mn by oxidizing the surface of the aluminum with KMnO₄;
EP 3716378, wherein surface treatment with several kinds of particles is obtained by adhesion to the aluminium by means of a polymer binder that sticks those particles to the surface of metal;
US 2014/0127574, wherein copper or aluminium foils are protected by a film of carbon fine particles adhered to the foil through a crosslinked polysaccharide polymer;
Electrochimica Acta 176 (2015) 604-609, where carbon particles are put on the surface of a copper foil.

A particularly preferred embodiment of the present invention is directed to a process for the preparation of an assembly wherein the surface-modified metal foil (M) is an aluminium foil modified with a surface layer (SL) of conductive carbons particles on at least one side of the foil.

In the present invention, the terms “1,1-difluoroethylene”, “1,1-difluoroethene” and “vinylidene fluoride” are used as synonyms and the terms “poly-(1,1-difluoroethylene)” and “polyvinylidene fluoride” are used as synonyms.

The expression “partially fluorinated polymer” is intended to denote a polymer comprising recurring units derived from at least one fluorinated monomer and, optionally, at least one hydrogenated monomer, wherein at least one of said fluorinated monomer and said hydrogenated monomer comprises at least one hydrogen atom.

The term “semi-crystalline” is hereby intended to denote a polymer (F) having a heat of fusion of from 2 to 90 J/g, preferably of from 5 to 60 J/g, as measured according to ASTM D3418-08.

Advantageously, said polymer (F) is characterized by an intrinsic viscosity higher than 0.05 L/g, more preferably higher than 0.12 L/g and even more preferably higher than 0.25 L/g, the intrinsic viscosity being measured as the dropping time of a solution of said polymer (F) at 25° C. at a concentration of 0.2 g/dL in N.N-dimethylformamide using a Ubbelhode viscosimeter, as detailed in the Experimental Section.

Preferably, said polymer (F) comprising recurring units derived from 1,1-difluoroethylene (VDF) and recurring units derived from at least one hydrogenated monomer comprising at least one carboxylic acid group [monomer (MA)] and/or recurring units derived from at least one partially or fully fluorinated monomer [monomer (F_{FH})], said monomer (F_{FH}) being different from VDF.

By the term “fluorinated monomer” it is intended to denote an ethylenically unsaturated monomer comprising at least one fluorine atom.

By the term “hydrogenated monomer” it is intended to denote an ethylenically unsaturated monomer comprising at least one hydrogen atom and free from fluorine atoms.

The expression “at least one fluorinated monomer” is intended to indicate that the polymer may comprise recurring units derived from one or more than one fluorinated monomers.

The expression “fluorinated monomers” is intended both in the plural and the singular, that is to say that they denote both one or more than one fluorinated monomers as defined above;

The expression “at least one hydrogenated monomer” is intended to indicate recurring units derived from one or more than one hydrogenated monomers.

The expression “hydrogenated monomers” is intended both in the plural and the singular, that is to say that they denote both one and more than one hydrogenated monomers as defined above.

According to a preferred embodiment, said polymer (F) comprises, more preferably consists of:
(I) recurring units derived from VDF and
(II) recurring units derived from at least one monomer (MA).

Preferably, said polymer (F) comprises, more preferably consists of:
at least 90% by moles, preferably at least 95% by moles, more preferably at least 97% by moles of recurring units derived from VDF,
from 0.05% to 10% by moles, preferably from 0.1% to 5% by moles, more preferably from 0.2% to 3% by moles of recurring units derived from at least one monomer (MA).

According to a preferred embodiment, said polymer (F) comprises, more preferably consists of:
(I) recurring units derived from VDF,
(II) recurring units derived from at least one monomer (MA) and
(III) recurring units derived from at least one monomer (F_{FH}).

Preferably, according to said embodiment, polymer (F) comprises, more preferably consists of:
at least 80% by moles, preferably at least 85% by moles, more preferably at least 90% by moles of recurring units derived from VDF,
from 0.01% to 10% by moles, preferably from 0.05% to 5% by moles, more preferably from 0.1% to 1.5% by moles of recurring units derived from at least one monomer (MA), and
from 0.1% to 15% by moles, preferably from 0.5% to 12% by moles, more preferably from 1% to 10% by moles of at least one monomer (F_{FH}).

Advantageously, polymer (F) according to this embodiment is characterized by an intrinsic viscosity higher than 0.25 L/g and lower than 0.60 L/g, the intrinsic viscosity being measured as the dropping time of a solution of said polymer (F) at 25° C. at a concentration of 0.2 g/dL in N.N-dimethylformamide using a Ubbelhode viscosimeter, as detailed in the Experimental Section.

In another particularly preferred embodiment of the present invention, said polymer (F) comprises, more preferably consists of:
at least 80% by moles, preferably at least 85% by moles, more preferably at least 90% by moles of recurring units derived from VDF,
from 0.01% to 10% by moles, preferably from 0.05% to 5% by moles, more preferably from 0.1% to 1.5% by moles of recurring units derived from at least one monomer (MA), and
from 5% to 12% by moles, more preferably from 6% to 10% by moles of at least one monomer (F_{FH}).

Advantageously, polymer (F) according to this embodiment is characterized by an intrinsic viscosity higher than 0.25 L/g and lower than 0.60 L/g, the intrinsic viscosity being measured as the dropping time of a solution of said polymer (F) at 25° C. at a concentration of 0.2 g/dL in N.N-dimethylformamide using a Ubbelhode viscosimeter, as detailed in the Experimental Section.

The polymer (F) may be obtained by polymerization of a VDF monomer, at least one monomer (MA) and at least one monomer (F_{FH}) according to the teaching, for example, of WO 2008/129041.

According to another embodiment, said polymer (F) comprises, preferably consists of:
(I) recurring units derived from VDF, and
(II) recurring units derived from at least one monomer (F_{FH}).

More preferably, said polymer (F) comprises:
at least 80% by moles, preferably at least 85% by moles, more preferably at least 90% by moles of recurring units derived from VDF, and
from 0.1% to 15% by moles, preferably from 0.5% to 12% by moles, more preferably from 1% to 10% by moles of at least one monomer (F_{FH}) as above defined.

Advantageously, polymer (F) according to this embodiment is characterized by an intrinsic viscosity higher than 0.05 L/g and lower than 0.60 L/g, more preferably lower than 0.25 L/g, the intrinsic viscosity being measured as the dropping time of a solution of said polymer (F) at 25° C. at a concentration of 0.2 g/dL in N.N-dimethylformamide using a Ubbelhode viscosimeter, as detailed in the Experimental Section.

Determination of average mole percentage of recurring units derived from at least one monomer (MA) in the polymer (F) can be performed by any suitable method. Mention can be notably made of acid-base titration methods, well suited e.g. for the determination of the acrylic acid content, of NMR methods, adequate for the quantification of monomers (MA) as above defined comprising aliphatic hydrogen atoms in side chains, of weight balance based on total fed monomer (MA) and unreacted residual monomer (MA) during polymer (F) manufacture.

Advantageously, said monomer (MA) complies with the following formula (I):

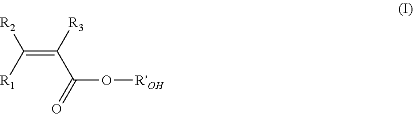

wherein:
R₁, R₂ and R₃, equal to or different from each other, are independently selected from a hydrogen atom and a C₁-C₃ hydrocarbon group and R′_{OH} is H or a C₁-C₅ hydrocarbon moiety comprising at least one carboxyl group.

Preferably, said monomer (MA) is acrylic acid (AA).

Preferably, said monomer (F_{FH}) is selected in the group comprising, more preferably consisting of:
C₂-C₈ perfluoroolefins, such as tetrafluoroethylene (TFE) and hexafluoropropylene (HFP);
C₂-C₈ hydrogenated fluoroolefins different from VDF, such as vinyl fluoride, 1,2-difluoroethylene and trifluoroethylene;
CH₂═CH—R_{f0} wherein R_{f0} is a C₁-C₆ perfluoroalkyl;
chloro- and/or bromo- and/or iodo-C₂-C₆ fluoroolefins, such as chlorotrifluoroethylene (CTFE);
CF₂═CFOX₀
   wherein X₀ is a C₁-C₆ fluoro- or perfluoroalkyl, e.g. CF₃, C₂F₅, C₃F₇; a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group; group —CF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;
CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form;
fluorodioxoles, preferably perfluorodioxoles.

More preferably, said monomer (F_{FH}) is selected in the group comprising, preferably consisting of: vinyl fluoride (VF₁), chlorotrifluoroethylene (CTFE), hexafluoropropylene (HFP), tetrafluoroethylene (TFE), trifluoroethylene (TrFE) and perfluoromethylvinylether (PMVE).

Polymer (F) is typically obtainable by emulsion polymerization or suspension polymerization according to the methods known to the skilled person in this field.

For the purpose of the present invention, the term “liquid medium [medium (L)]” is intended to denote a medium comprising one or more substances in the liquid state at 20° C. under atmospheric pressure.

The medium (L) is typically free from any solvent suitable for dissolving polymer (F) as defined above, that is, any polar solvent, typically including N-methyl-2-pyrrolidone (NMP), N,N-dimethylformamide, N,N-dimethylacetamide, dimethylsulfoxide, hexamethylphosphamide, dioxane, tetrahydrofuran, tetramethylurea, triethyl phosphate, trimethyl phosphate; and mixtures thereof.

Said medium (L) is preferably selected from organic carbonates, ionic liquids (IL), sulfones or mixture thereof.

According to a first embodiment of the invention, said medium (L) comprises at least one organic carbonate as the only medium (L).

Non-limiting examples of suitable organic carbonates include, notably, ethylene carbonate, propylene carbonate, mixtures of ethylene carbonate and propylene carbonate, dimethyl carbonate, diethyl carbonate, ethyl-methyl carbonate, butylene carbonate, vinylene carbonate, fluoroethylene carbonate, fluoropropylene carbonate and mixtures thereof.

According to a second embodiment of the invention, said medium (L) comprises at least one ionic liquid (IL) as the only medium (L).

By the term “ionic liquid (IL)”, it is hereby intended to denote a compound formed by the combination of positively charged cations and negatively charged anions which exists in the liquid state at temperatures below 100° C. under atmospheric pressure.

The ionic liquid (IL) can be selected from protic ionic liquids (ILₚ), aprotic ionic liquids (ILₐ) and mixtures thereof.

By the term “protic ionic liquid (ILₚ)”, it is hereby intended to denote an ionic liquid wherein the cation comprises one or more H⁺ hydrogen ions.

Non-limitative examples of cations comprising one or more H⁺ hydrogen ions include, notably, imidazolium, pyridinium, pyrrolidinium or piperidinium rings, wherein the nitrogen atom carrying the positive charge is bound to a H⁺ hydrogen ion.

By the term “aprotic ionic liquid (ILₐ)”, it is hereby intended to denote an ionic liquid wherein the cation is free of H⁺ hydrogen ions.

The ionic liquid (IL) is typically selected from those comprising as cation a sulfonium ion or an imidazolium, pyridinium, pyrrolidinium or piperidinium ring, said ring being optionally substituted on the nitrogen atom, in particular by one or more alkyl groups with 1 to 8 carbon atoms, and on the carbon atoms, in particular by one or more alkyl groups with 1 to 30 carbon atoms.

According to a third embodiment of the invention, said medium (L) comprises a mixture of at least one organic carbonate as defined above and at least one ionic liquid (IL) as defined above.

Non-limiting examples of suitable sulfones are those of formula:

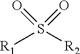

wherein R₁ and R₂ are independently any of the following: a free hydrogen, a C₁-C₂₀ alkyl group, a linear C₁-C₆ alkyl group or R₁ and R₂ taken together are a C₃-C₂₀ cycloalkyl group or a C₆-C₃₀ aryl group.

More preferably, the sulfone is sulfolane (tetramethylene sulfone).

Optionally, said medium (L) further comprises at least one metal salt [salt (M)].

Said salt (M) is typically selected from the group consisting of:
(a) MeI, Me(PF₆)ₙ, Me(BF₄)ₙ, Me(ClO₄)ₙ, Me(bis(oxalato)borate)ₙ (“Me(BOB)ₙ”), MeCF₃SO₃, Me[N(CF₃SO₂)₂]ₙ, Me[N(C₂F₅SO₂)₂]ₙ, Me[N(CF₃SO₂)(R_{F}SO₂)]ₙ, wherein R_{F} is C₂F₅, C₄F₉ or CF₃OCF₂CF₂, Me(AsF₆)ₙ, Me[C(CF₃SO₂)₃]ₙ, Me₂Sₙ,
wherein Me is a metal, preferably a transition metal, an alkaline metal or an alkaline-earth metal, more preferably Me being Li, Na, K, Mg, Al or Cs, even more preferably Me being Li, and n is the valence of said metal, typically n being 1 or 2,
(b)

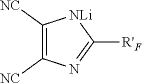

wherein R′_{F} is selected from the group consisting of F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ and CF₂OCF₃, and
(c) combinations thereof.

Said salt (M) is advantageously dissolved by said medium (L).

On this regard, the concentration of said salt (M) in the medium (L) is advantageously at least 0.01 M, preferably at least 0.025 M, more preferably at least 0.05 M.

The concentration of the salt (M) in the medium (L) is advantageously at most 5 M, preferably at most 3 M, more preferably at most 2 M, even more preferably at most 1 M.

By the term “electro-active compound [compound (EA)]” is intended to denote any inorganic or organic electro-active material capable of absorbing and/or emitting ions and electrons during cell operation.

By “inorganic electro-active materials” it is hereby intended to denote any compound which is able to incorporate or insert into its structure and substantially release therefrom alkaline or alkaline-earth metal ions during the charging phase and the discharging phase of an electrochemical device. The inorganic electro-active materials are preferably able to incorporate or insert and release lithium ions.

The nature of the inorganic electro-active material in composition (C) and as a consequence in layer (L1) of the assembly of the invention, depends on whether the final assembly thereby provided is a positive electrode [electrode (Ep)] or a negative electrode [electrode (En)].

In the case of forming a positive electrode for a lithium-ion secondary battery, said inorganic electro-active materials may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still in the case of forming a positive electrode for a lithium-ion secondary battery, the inorganic electro-active materials may comprise a lithiated or partially lithiated transition metal oxyanion-based electro-active material of formula M₁M₂(JO₄)_{f}E_{1-f}, wherein M₁ is lithium, which may be partially substituted by another alkali metal representing less that 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the inorganic electro-active materials has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the compound (EA) is a phosphate-based electro-active material of formula Li(FeₓMn₁₋ₓ)PO₄ wherein 0≤x≤1, wherein x is preferably 1 (that is to say, lithium iron phosphate of formula LiFePO₄).

Preferably, said inorganic electro-active materials is selected from lithium-containing complex metal oxides of general formula (II)

LiNiₓM¹_{y}M²_{z}Y₂ (II)
wherein M¹ and M² are the same or different from each other and are transition metals selected from Co, Fe, Mn, Cr and V,
0.5≤x≤1,
wherein y+z=1−x, and
Y denotes a chalcogen, preferably selected from O and S.

The positive inorganic electrode active material is preferably a compound of formula (II) wherein Y is O.

In a preferred embodiment, M¹ is Mn and M² is Co.

In another preferred embodiment, M¹ is Co and M² is Al.

Examples of such active materials include LiNiₓMn_{y}Co_{z}O₂, herein after referred to as NMC, and LiNiₓCo_{y}Al_{z}O₂, herein after referred to as NCA.

Specifically with respect to LiNiₓMn_{y}Co_{z}O₂, varying the content ratio of manganese, nickel, and cobalt can tune the power and energy performance of a battery.

In a preferred embodiment of the present invention, the inorganic active material is a compound of formula (II) as above defined, wherein 0.5≤x≤1, 0.1≤y≤0.5, and 0≤z≤0.5.

Non imitative examples of suitable positive inorganic electrode active materials of formula (II) include, notably:
LiNi_{0.33}Mn_{0.33}Co_{0.33}O₂
LiNi_{0.5}Mn_{0.3}Co_{0.2}O₂,
LiNi_{0.6}Mn_{0.2}Co_{0.2}O₂,
LiNi_{0.8}Mn_{0.1}Co_{0.1}O₂,
LiNi_{0.8}Co_{0.15}Al_{0.05}O₂, and
LiNi_{0.8}Co_{0.2}O₂.

Inorganic active materials which have been found particularly advantageous are LiNi_{0.8}Co_{0.15}Al_{0.05}O₂, LiNi_{0.6}Mn_{0.2}Co_{0.2}O₂ and LiNi_{0.8}Mn_{0.1}Co_{0.1}O₂.

In the case of forming a negative electrode (En) for a Lithium-ion secondary battery, the inorganic electro-active material may preferably comprise a carbon-based material and/or a silicon-based material.

In some embodiments, the carbon-based material may be, for example, graphite, such as natural or artificial graphite, graphene, or carbon black.

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon and silicon oxide. More particularly, the silicon-based compound may be silicon oxide or silicon carbide.

When present in inorganic electro-active materials, the at least one silicon-based compound is comprised in the inorganic electro-active materials in an amount ranging from 1 to 50% by weight, preferably from 5 to 20% by weight with respect to the total weight of the inorganic electro-active materials.

For the purpose of the present invention, the term “organic electro-active material” is intended to denote a compound that comprises an organic molecule or polymer exhibiting either n-type, p-type or bipolar-type redox behaviour.

Some specific examples of organic electro-active compounds are for instance listed in Table 1 of Tyler B. Schon, Bryony T. McAllister, Peng-Fei Li and Dwight S. Sefero, Chem. Soc. Rev., 2016, 45, 6345.

Preferably, the electro-active compound [compound (EA)] is an inorganic electro-active material.

Advantageously, said composition (C) further comprises a conductive compound [compound (CC)], which is able to impart or to improve the electron conductivity of the electro-active compound (EA).

Examples thereof may include: carbonaceous materials, such as carbon black, graphite fine powder carbon nanotubes, graphene, or fibers, or fine powder or fibers of metals such as nickel or aluminum.

Said compound (CC) is preferably selected from carbon black or graphite.

For sake of clarity, compound (CC) is different from the carbon-based material described above for the negative electrode (En).

Preferably, said compound (CC) is present in said composition (C) in an amount from 0.1 wt. % to 15 wt. %, more preferably from 0.25 to 12 wt. % based on the total weight of said composition (C).

Advantageously, said composition (C) further comprises at least one polymer [polymer (P)] comprising a backbone complying with the following formula:

—[(CH₂)ₓ—CHR¹—R²)—
wherein
x is in integer from 1 to 3,
R¹ is hydrogen or methyl group; and
R² is oxygen atom or a group of formula —OC(═O)R³ with R³ being hydrogen atom or methyl.

Preferably, said polymer (P) has a melting point (Tm) lower than 120° C., more preferably lower than 100° C., even more preferably lower than 90° C.

Preferably, said polymer (P) has a melting point (Tm) higher than 25° C., more preferably higher than 30° C., even more preferably higher than 40° C.

Advantageously, when present, said polymer (P) is present in said composition (C) in an amount higher than 0.1 wt. %, preferably higher than 0.5 wt. % and more preferably higher than 1 wt. % based on the total weight of said composition (C).

Advantageously, said polymer (P) is present in said composition (C) in an amount lower than 20 wt. %, preferably lower than 10 wt. % and more preferably lower than 8 wt. % based on the total weight of said composition (C).

In a preferred embodiment, said polymer (P) is selected in the group comprising, preferably consisting of, polyalkylene oxide, such as notably polyethylene oxide (PEO), polypropylene oxide (PPO), polybutylene oxide; and poly(vinyl ester), such as poly (vinyl acetate).

In a preferred embodiment, composition (C) according to the present invention comprises:
from 3 to 20 w. % of said medium (L) as defined above, optionally comprising at least one salt (M) as defined above;
from 2 to 14 w. % of said polymer (F) as defined above;
from 50 to 97 wt. % of said compound (EA) as defined above;
from 0.5 to 10 wt. % of said compound (C); and
optionally, from 3 to 5 wt. % of said polymer (P),
wherein the above amounts are based on the total weight of said composition (C).

Composition (C) can be advantageously prepared by methods known to the person skilled in the art.

Composition (C) is preferably obtained in the form of paste.

In a preferred embodiment, composition (C) is prepared by mixing the components in a suitable mixing device, such as a kneader or a mixer comprising two co-rotating interpenetrating screws rotating in a closed sleeve. Mixing is carried out preferably at room temperature.

In step (iii) of the process of the present invention, composition (C) provided in step (ii) is mixed at a temperature lower than 50° C. prior to start the extrusion step.

Mixing step (iii) can be carried out in a standard mixing devices

Composition (C) after the mixing step (iii) may be in the form of granules, these granules being formed at the outlet of the mixing devices by means, for example, of a rounded die placed at the outlet of the mixer, so as to form a ring, this die being provided with a cutting system arranged at the outlet mixer.

In an alternative embodiment of the invention, mixing step (iii) is carried out in the same equipment for extrusion step (iv), wherein composition (C) provided in step (ii) is fed through a feeder, mixed in a first zone of the extruder set at a temperature lower than 50° C. and then submitted to the extrusion step (iv) to provide a sheet of composition (C) through a die opening.

The equipment for mixing step (iii) and extrusion step (iv) is preferably a twin-screw extruder.

In step (iv) the mixed composition (C) obtained in step (iii) is conveyed through a die, preferably a flat die, thereby providing a sheet of composition (C).

The die at the end of the extruder is preferably a die having rectangular geometry.

The thickness of the sheet of composition (C) to be deposited onto the surface-modified metal foil (M) provided in step (i) shall be in the range of from 50 to 300 microns in order to be suitably co-laminated. Thus, before deposition onto the surface of the metal foil, the sheet of composition (C) may optionally be laminated in step (v), so as to reduce its thickness to a thickness in the range of from 50 to 300 microns. The sheet of composition (C) thus laminated can be deposited on at least one surface of the metal foil via a step of co-lamination with the metal foil.

The term “co-lamination” refers to the lamination of the sheet of composition (C) onto at least one surface of the metal foil to provide an electrode.

In one embodiment, the present invention thus provides a process for the manufacture of an assembly, said process comprising:
(i) providing a surface-modified metal foil (M) having at least one side that is at least partially chemically modified;
(ii) providing an electrode-forming composition [composition (C)] as above defined
   optionally, a polymer [polymer (P)] as above defined;
(iii) mixing said composition (C) in a mixing device at a temperature lower than 50° C.;
(iv) extruding the mixed composition (C) obtained in step (iii) through a die opening to provide a sheet of composition (C);
(v) laminating the sheet of composition (C) obtained in step (iv) to provide a sheet of composition (C) having a thickness in the range of from 50 to 300 microns;
(vi) depositing the sheet of composition (C) obtained in step (iv) onto at least one side of the surface-modified metal foil (M) provided in step (i), thereby providing an assembly comprising a surface-modified metal foil (F) having at least part of at least one side that is coated with a layer (L1) consisting of said composition (C).

The assembly obtained at the end of step (vi) may further be submitted to a step of calendering the assembly, so as to increase its volume energy density.

The manufacturing process can be a continuous process, that is to say a process which takes place without interruption during the entire period of its operation, which means, in other words, that the assembly is manufactured without interruption throughout the implementation of the process. Step (iii), step (iv), step (v) and step (vi) can thus be implemented concomitantly and without interruption throughout the duration of the process, which means, in other words, that at each instant of the duration of the process, a fraction of the composition (C) is subjected to the mixing step (iii) while another fraction of the composition is subjected to the extrusion step (iv), another fraction is laminated in step (v) and another fraction, in the form of an sheet of composition (C), is co-laminated onto the metal foil in step (vi). It is also understood, in this case, that all the optional steps of the process (for example, the laminating and calendering step) are, when present, carried out continuously.

The process of the present invention allows obtaining an assembly that comprises:
at least one surface-modified metal foil (M), and
directly adhered onto at least part of at least one side of said surface-modified metal foil (M), at least one layer (L1) consisting of a composition (C) comprising:
at least one polymer (F) as defined above,
at least one liquid medium [medium (L)] as defined above
at least one compound (EA) as defined above.

In one embodiment of the present invention, the assembly comprises:
at least one surface-modified metal foil (M), and
directly adhered onto at least part of one side of said surface-modified metal foil (M), at least one layer (L1) consisting of a composition (C) comprising:
at least one polymer (F) as defined above,
at least one liquid medium [medium (L)] as defined above
at least one compound (EA) as defined above.

In another embodiment of the present invention, the assembly comprises:
at least one surface-modified metal foil (M), and
directly adhered onto at least part of both the two sides of said surface-modified metal foil (M), at least one layer (L1) consisting of a composition (C) comprising:
at least one polymer (F) as defined above,
at least one liquid medium [medium (L)] as defined above
at least one compound (EA) as defined above.

The assembly according to said embodiment is thus a so called double-sided assembly.

Advantageously, said assembly is an electrode [electrode (E)]. More preferably, said electrode (E) is a positive electrode [electrode (Ep)] or a negative electrode [electrode (En)].

Without wishing to be bound by theory, the Applicant believes that the process of the present invention, thanks to the use of metal foil that has at least one surface that is at least partly modified, allows obtaining high performance electrodes by means of a continuous and very efficient process.

The electrode (E) of the invention is particularly suitable for use in electrochemical devices.

By the term “electrochemical device”, it is hereby intended to denote an electrochemical cell/assembly comprising a positive electrode, a negative electrode, wherein a monolayer or multilayer separator is in contact to at least one surface of one of the said electrodes. Non-limitative examples of suitable electrochemical devices include, notably, secondary batteries, especially, alkaline or an alkaline-earth secondary batteries such as lithium ion batteries and capacitors, especially lithium ion-based capacitors and electric double-layer capacitors (supercapacitors).

By the term “secondary battery” is intended to denote a rechargeable battery.

In particular, the present invention further pertains to a secondary battery comprising:
a positive electrode,
a negative electrode, and
between said positive electrode and said negative electrode, a membrane,
wherein at least one of the positive electrode and the negative electrode is the electrode (E) of the invention.

By the term “membrane”, it is hereby intended to denote a discrete, generally thin, interface which electrically and physically separates the electrodes of opposite polarities in an electrochemical device and is permeable to ions flowing between them.

In the present invention, the membrane can be any electronic insulating substrate commonly used for a separator in an electrochemical device.

In one embodiment, the membrane is a porous polymeric material comprising at least one material selected from the group consisting of polyester such as polyethylene terephthalate and polybutylene terephthalate, polyphenylene sulphide, polyacetal, polyamide, polycarbonate, polyimide, polyether sulfone, polyphenylene oxide, polyphenylene sulfide, polyethylene naphthalene, polyethylene oxide, polyacrylonitrile, polyolefin such as polyethylene and polypropylene, or mixtures thereof.

In a particular embodiment, the membrane is a porous polymeric material coated with PVDF or inorganic nanoparticles, for instance, SiO₂, TiO₂, Al₂O₃, ZrO₂, etc.

It will be apparent to the person skilled in the art that once the battery is assembled, medium (L) as defined above comprising salt (M) as defined above, can be further added to the secondary battery. Said medium (L) and said salt (M) being the same or different from medium (L) and salt (M) defined for composition (C) above.

According to a first embodiment of the invention, the membrane comprises a fluoropolymer hybrid organic/inorganic composite, said hybrid being obtainable by a process such as that disclosed in WO 2015/169834.

According to an embodiment of the invention, the secondary battery comprises:
a positive electrode [electrode (Ep)],
a negative electrode, and
between said electrode (Ep) and said negative electrode, a membrane as defined above.

The negative electrode of the secondary battery of this embodiment of the invention is typically a metal substrate, preferably a foil made from a metal such as lithium or zinc.

Alternatively, the negative electrode of the secondary battery of this embodiment of the invention can be an electrode as described for example in WO 2017/017023.

According to another embodiment of the invention, the secondary battery comprises:
a positive electrode,
a negative electrode [electrode (En)], and
between said positive electrode and said electrode (En), a membrane as defined above.

According to another embodiment of the invention, the secondary battery comprises:
a positive electrode [electrode (Ep)],
a negative electrode [electrode (En)], and
between said electrode (Ep) and said electrode (En), a membrane as defined above.

In one preferred embodiment, the present invention provides a secondary battery comprising:
a positive electrode [electrode (Ep)],
a negative electrode selected from a negative electrode made from a metal such as lithium or zinc or a negative electrode as described in WO 2017/017023, and
between said electrode (Ep) and said negative electrode, a membrane comprising a fluoropolymer hybrid organic/inorganic composite, said hybrid being obtainable by a process such as that disclosed in WO 2015/169834.

Should the disclosure of any patents, patent applications, and publications which are incorporated herein by reference conflict with the description of the present application to the extent that it may render a term unclear, the present description shall take precedence.

The invention will be now described in more details with reference to the following examples whose purpose is merely illustrative and not limitative of the scope of the invention.

### Experimental Section

### Materials

Polymer-1: VDF-AA (0.9% by moles)-HFP (2.4% by moles) polymer having an intrinsic viscosity of 0.28 L/g in DMF at 25° C. and Tm=148° C.
Polymer-2: VDF-HFP (2.5% by moles)-HEA (0.4% by moles) polymer having an intrinsic viscosity of 0.117 l/g in DMF at 25° C. and a Tₘ of 154.2° C.
Polymer (F-1): VDF-AA (0.5% by moles)-HFP (6.5% by moles) polymer having an intrinsic viscosity of 0.32 L/g in DMF at 25° C. and Tm=127° C.
Carbon black, commercially available as Super® C45 and Super® C65.
Graphite: 75% SMG HE2-20 (Hitachi Chemical Co., Ltd.)/25% TIMREX® SFG 6.
NMC622: Produced by Umicore
Vinylene carbonate (VC), commercially available from Sigma Aldrich.
Medium (L1): ethylene carbonate (EC)/propylene carbonate (PC) 1/1 by volume containing 1M of LiPF₆ with 2 wt % of VC.
TSPI: 3-(triethoxysilyl)propyl isocyanate
DBTDL: dibutyltin dilaurate
TEOS: (tetraethoxysilane) Si(OC₂H₅)₄.
Coated-Al current collector: Showa Denko SDX®-ZM carbon coated

### Methods

### Determination of Intrinsic Viscosity of Polymers −1, −2 and (F-1)

Intrinsic viscosity (η) [dl/g] was measured using the following equation on the basis of dropping time, at 25° C., of a solution obtained by dissolving each of the polymers in N,N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where
c is polymer concentration [g/dl],
ηᵣ is the relative viscosity, i.e. the ratio between the dropping time of sample solution and the dropping time of solvent, ηₛₚ is the specific viscosity, i.e. ηᵣ−1, and Γ is an experimental factor, which for these polymers corresponds to 3.

### DSC Analysis

DSC analyses were carried out according to ASTM D 3418 standard; the melting point (Tm) was determined at a heating rate of 10° C./min.

### EXAMPLE 1: PREPARATION OF POSITIVE ELECTRODE ACCORDING TO THE INVENTION

The following ingredients, in the amounts reported below, were introduced in a closed mixer at room temperature ° C.:
Active material: NMC622 80.75 wt %
Polymer (F-1): 2.55 wt %
Carbon black: 1.7 wt %
Liquid-Medium (L1): 15 wt %

Then this composition was fed to a twin screw extruder at 80° C.-90 ° C. from which a sheet of this composition exits from a die with a thickness of 1300 microns. The thickness of the sheet was then reduced by successive passes using a 4″ width electric hot rolling press (MSK-HRP-01 de MTI corporation®) at a lamination speed of V=20 mm/sec between two protecting liners (poly(ethylene terephthalate) PET, 125 microns thick). At each pass, the distance between the two rolls was decreased by ±20% of the thickness of the sheet reached at the previous pass. Thus, depending on the number of successive lamination passes at a temperature between 80° C. and 100° C., sheets of different thicknesses between 89 and 100 microns were prepared.

Then this sheet of the electrode composition of the invention was co-laminated on a coated-Al current collector. The conditions of co-lamination were the same conditions used for the lamination, but with the distance between the rolls being adjusted to obtain the proper electrode thickness Single-side positive electrode was prepared by co-laminating one composition sheet of the invention on one side of the coated-Al current collector. Double-side positive electrodes were also prepared by co-laminating two sheets of the composition of the invention with same thickness on each side of the coated-Al current collector.

The positive electrode is characterized by a surface capacity (loading) of 4.2 to 5 mAh/cm² per side.

### Anode Preparation (According to WO 2017/017023)

A solution of polymer-1 in MEK was prepared at 40° C. and then brought to room temperature. Then, graphite was added to the solution so obtained in a weight ratio of 95/5 (Graphite/Polymer-1). Then the liquid medium(L1) was added to the solution. The weight ratio [m_{liquid medium(L1)}/(m_{liquid medium(L1)}+m_{copolymer-1})]×100 was 80%.

The solution mixture was then spread with a constant thickness onto a copper current collector foil using a machine roll-to-roll. The thickness was controlled by the distance between the knife and the metal collector. Several loadings were prepared on one and double-sided coating. The solvent was then evaporated from said mixture thereby providing the electrode. The electrode was finally calendared. In conclusion, three different portions of electrode were obtained: first portion one-sided coating at 5.26 mAh/cm² with a final thickness of 113 microns, a second portion double-sided coating at 5.89 mAh/cm² per side and a final thickness of 238 microns and a third portion double-sided coating with a loading of 4.89 mAh/cm² and a final thickness of 210 microns.

### Membrane Preparation According to WO 2015/169834

The polymer-2 (40 g) was dissolved in 275 g of acetone at 60° C. thereby providing a solution containing 12.7% by weight of said polymer-2. The solution was homogeneous and transparent after homogenization at 60° C. DBTDL (0.21 g) was then added. The solution was homogenized at 60° C. TSPI (0.82 g) was added thereto. The quantity of DBTDL was calculated to be 10% by moles vs. TSPI. TSPI itself was calculated to be 0.55% by mole vs. the polymer-2. The solution was kept at 60° C. for about 90 min so as to let isocyanate functional groups of TSPI to react with the hydroxyl groups of the polymer-2.

In the next step, the liquid medium (L1) was added to the solution so obtained.

The weight ratio [m_{(liquid medium(L1))}/(m_{(liquid medium(L1))}+m_{(Polymer-2)})] was 80%. After homogenization at 60° C., formic acid was added.

TEOS was then added thereto. The quantity of TEOS was calculated from the weight ratio (m_{(SiO2)}/m_{(polymer-2)}) assuming total conversion of TEOS into SiO₂. This ratio was 10%.

The quantity of formic acid was calculated from the following equation:

n_{(formic acid)}/n_{(TEOS)}=2.6.

All the ingredients were fed to the solution mixture so obtained under Argon atmosphere. The solution mixture was spread with a constant thickness onto a PET substrate using a roll-to-roll machine in a dry room (dew point: −40° C.). The thickness was controlled by the distance between the knife and the PET film.

The solvent was quickly evaporated from the solution mixture and the membrane was obtained. After a few hours, the membrane was detached from the PET substrate. The membrane so obtained had a constant thickness of 55 μm.

### EXAMPLE 2: PREPARATION OF THREE POUCH Li-ION BATTERY CELLS

Three pouch cells have been assembled by using one single-sided positive electrode of the invention of example 1 (lamination and co-lamination at 80° C.) characterized by a loading of 4.5 mAh/cm² and one single-sided anode characterized by a loading of 5.3 mAh/cm² and a membrane as above described.

The surface area of the positive electrode was 10.24 cm² and that of the negative electrode was 12.25 cm².

The discharge capacity values of the three pouch cells under different C-rates are shown in Table 1. It is clear that all of them work properly and are reproducible.

TABLE 1

| Cycling conditions | | | | | |
|---|---|---|---|---|---|
| T | | Cycle | mAh | | |
| ° C. | C-rate | index | Cell 1 | Cell 2 | Cell 3 |
| 45 | C/20-D/20 | 0 | 39.88 | 43.35 | 42.87 |
| 45 | | 1 | 39.25 | 42.70 | 42.45 |
| RT | | 2 | 35.46 | 39.60 | 39.35 |
| RT | C/10-D/10 | 3 | 31.05 | 35.78 | 35.85 |
| RT | | 4 | 31.26 | 35.54 | 35.79 |
| RT | | 5 | 31.23 | 35.36 | 35.71 |
| RT | | 6 | 31.22 | 35.22 | 35.65 |
| RT | | 7 | 31.24 | 35.13 | 35.63 |
| RT | C/5-D/5 | 8 | 22.98 | 25.49 | 27.02 |
| RT | | 9 | 23.02 | 25.45 | 26.89 |
| RT | | 10 | 22.96 | 25.38 | 26.79 |
| RT | | 11 | 22.92 | 25.27 | 26.64 |
| RT | | 12 | 22.78 | 25.19 | 26.52 |
| RT | C/5-D/2 | 13 | 12.48 | 12.77 | 14.70 |
| RT | | 14 | 13.02 | 13.42 | 15.30 |
| RT | | 15 | 13.24 | 13.72 | 15.57 |
| RT | | 16 | 13.34 | 13.87 | 15.69 |
| RT | | 17 | 13.38 | 13.95 | 15.76 |
| RT | C/5-D | 18 | 6.23 | 6.19 | 7.94 |
| RT | | 19 | 6.44 | 6.48 | 8.21 |
| RT | | 20 | 6.54 | 6.63 | 8.35 |
| RT | | 21 | 6.61 | 6.72 | 8.42 |
| RT | | 22 | 6.64 | 6.80 | 8.46 |
| RT | C/5-2D | 23 | 1.13 | 1.22 | 1.56 |
| RT | | 24 | 1.15 | 1.23 | 1.58 |
| RT | | 25 | 1.15 | 1.24 | 1.59 |
| RT | | 26 | 1.16 | 1.24 | 1.60 |
| RT | | 27 | 1.17 | 1.24 | 1.60 |
| RT | C/20-D/20 | 28 | 35.06 | 38.30 | 38.46 |
| RT | | 29 | 34.68 | 37.87 | 38.16 |
| RT | | 30 | 34.61 | 37.73 | 38.09 |
| RT | | 31 | 34.57 | 37.56 | 37.99 |
| RT | | 32 | 34.51 | 37.39 | 37.91 |
| RT | | 33 | 34.43 | 37.20 | 37.83 |
| RT | | 34 | 34.36 | 37.10 | 37.78 |
| RT | | 35 | 34.35 | 36.91 | 37.70 |
| RT | | 36 | 34.27 | 36.72 | 37.62 |
| RT | | 37 | 34.24 | 36.57 | 37.58 |
| RT | | 38 | 34.13 | 36.36 | 37.48 |

### EXAMPLE 3: PREPARATION OF TWO HIGH CAPACITY STACKED CELLS

Two high capacity cells were prepared by assembling 4 double-sided positive electrodes of the invention of example 1 (lamination and co-lamination at 100° C.), 3 double-sided and 2 single-sided anodes, and 8 membranes between each positive electrode and negative electrode described above. These electrodes were previously die-cut to have surface area of 16 cm² for the positive electrode and 17.22 cm² for the negative electrode, respectively. The electrode loadings of cell 1 and 2 were different: 4.2 mAh/cm² (vs negative electrode at 4.9 mAh/cm²) for cell 1 and 5.0 mAh/cm² (vs negative electrode at 5.9 mAh/cm²) for cell 2.

The discharge capacity values of the two high capacity cells (stacks) under different C-rates are shown in Table 2. It is clear that all of them work properly and are reproducible.

TABLE 2

Cycling conditions

| | | |
|---|---|---|
| T | Cycle | mAh |

| ° C. | C-rate | index | Cell 1 | Cell 2 |
|---|---|---|---|---|
| 45 | C/20-D/20 | 0 | 510.5 | 538.2 |
| 45° | | 1 | 507.0 | 531.3 |
| RT | | 2 | 485.5 | 517.3 |
| RT | C/10-D/10 | 3 | 455.5 | 417.0 |
| RT | | 4 | 455.1 | 428.7 |
| RT | | 5 | 454.9 | 434.5 |
| RT | | 6 | 454.8 | 439.2 |
| RT | | 7 | 454.5 | 442.4 |

1. A process for the manufacture of an assembly, said process comprising:
(i) providing a surface-modified metal foil (M) having at least one side that is at least partially chemically modified;
(ii) providing an electrode-forming composition [composition (C)] comprising:
from 0.5 wt. % to less than 20 wt. % of at least one semi-crystalline partially fluorinated polymer [polymer (F)] comprising recurring units derived from 1,1-difluoroethylene (VDF);
from 2 wt. % to less than 40 wt. % of at least one liquid medium [medium (L)] characterized by a boiling point higher than 100° C., wherein said medium (L) may optionally further comprise at least one metal salt [salt (M)];
at least 50 wt. % of at least one electro-active compound [compound (EA)];
optionally, a polymer [polymer (P)] comprising a backbone complying with the following formula:
—[(CH₂)ₓ—CHR¹—R²)—
wherein
x is in integer from 1 to 3,
R¹ is hydrogen or methyl group; and
R² is oxygen atom or a group of formula —OC(═O)R³ with R³ being hydrogen atom or methyl,
wherein the above amounts are based on the total weight of said composition (C);
(iii) mixing said composition (C) in a mixing device at a temperature lower than 50° C.;
(iv) extruding the mixed composition (C) obtained in step (iii) through a die opening at temperature comprised between 50 and 130° C. to provide a sheet of composition (C);
(v) optionally, laminating the sheet of composition (C) obtained in step (iv) to provide a sheet having a thickness in the range of from 50 to 300 microns;
(vi) depositing the sheet of composition (C) obtained in step (iv) or in step (v) onto at least one side of the surface-modified metal foil (M) provided in step (i), thereby providing an assembly comprising a surface-modified metal foil (F) having at least part of at least one side that is coated with a layer (L1) consisting of said composition (C).

2. The process according to claim 1, wherein the surface-modified metal foil (M) is a metal foil having a surface layer (SL), wherein said surface layer (SL) is formed by a surface treatment selected from the group consisting of chemical modification, chemical etching, electrochemical etching, electrodeposition, chemically oxidized processes, coating, corona discharge.

3. The process according to claim 1, wherein a coating treatment includes coating the surface with compositions comprising a binder and particles selected from the group consisting of conductive carbons, graphites, graphenes, carbon nanotubes, activated carbon fibers, non-activated carbon nanofibers, metal flakes, powders metal, metal fibers, metal oxides and electrically conductive polymers.

4. The process according to claim 1, wherein an average thickness of the surface layer (SL) of the surface of the metal foil (M) suitable for the process of the present invention is in the range from 0.5 nm to 50 μm.

5. The process according to claim 1, wherein polymer (F) comprises:
at least 80% by moles recurring units derived from VDF,
from 0.01% to 10% by moles of recurring units derived from at least one hydrogenated monomer comprising at least one carboxylic acid end group [monomer (MA)] and
from 5% to 12% by moles of at least one partially or fully fluorinated monomer [monomer (F_{FH})], said monomer (F_{FH}) being different from VDF.

6. The process according to claim 5, wherein monomer (MA) is acrylic acid.

7. The process according to claim 1, wherein liquid medium [medium (L)] is selected from organic carbonates, ionic liquids (IL), sulfones or mixture thereof.

8. The process according to claim 1, said process comprising:
(i) providing a surface-modified metal foil (M) having at least one side that is at least partially chemically modified;
(ii) providing an electrode-forming composition [composition (C)] comprising:
from 0.5 wt. % to less than 20 wt. % of at least one semi-crystalline partially fluorinated polymer [polymer (F)] comprising recurring units derived from 1,1-difluoroethylene (VDF);
from 2 wt. % to less than 40 wt. % of at least one liquid medium [medium (L)] characterized by a boiling point higher than 100° C., wherein said medium (L) may optionally further comprise at least one metal salt [salt (M)];
at least 50 wt. % of at least one electro-active compound [compound (EA)];
optionally, a polymer [polymer (P)] comprising a backbone complying with the following formula:
—[(CH₂)ₓ—CHR¹—R²)—
wherein
x is in integer from 1 to 3,
R¹ is hydrogen or methyl group; and
R² is oxygen atom or a group of formula —OC(═O)R³ with R³ being hydrogen atom or methyl,
wherein the above amounts are based on the total weight of said composition (C);
(iii) mixing said composition (C) in a mixing device at a temperature lower than 50° C.;
(iv) extruding the composition (C) obtained in step (iii) through a die opening at temperature comprised between 50 and 130° C. to provide a sheet of composition (C);
(v) laminating the sheet of composition (C) obtained in step (iv) to provide a sheet having a thickness in the range of from 50 to 300 microns;
(vi) depositing the sheet of composition (C) obtained in step (iv) or in step (v) onto at least one side of the surface-modified metal foil (M) provided in step (i), thereby providing an assembly comprising a surface-modified metal foil (F) having at least part of at least one side that is coated with a layer (L1) consisting of said composition (C).

9. The process according claim 1, which further comprises a step of calendering the assembly obtained at the end of step (vi).

10. An assembly obtainable with the process according to claim 1, said assembly comprising:
at least one surface-modified metal foil (M), and
directly adhered onto at least one surface of said surface-modified metal foil (M), at least one layer (L1) consisting of a composition (C) comprising:
from 0.5 wt. % to less than 20 wt. % of at least one semi-crystalline partially fluorinated polymer [polymer (F)] comprising recurring units derived from 1,1-difluoroethylene (VDF);
from 2 wt. % to less than 40 wt. % of at least one liquid medium [medium (L)] characterized by a boiling point higher than 100° C., wherein said medium (L) may optionally further comprise at least one metal salt [salt (M)];
at least 50 wt. % of at least one electro-active compound [compound (EA)];
optionally, a polymer [polymer (P)] comprising a backbone complying with the following formula:
—[(CH₂)ₓ—CHR¹—R²)—
wherein
x is in integer from 1 to 3,
R¹ is hydrogen or methyl group; and
R² is oxygen atom or a group of formula —OC(═O)R³ with R³ being hydrogen atom or methyl,
wherein the above amounts are based on the total weight of said composition (C).

11. The assembly according to claim 10 that comprises:
at least one surface-modified metal foil (M), and
directly adhered onto at least part of one side of said surface-modified metal foil (M), at least one layer (L1) consisting of a composition (C) comprising:
from 0.5 wt. % to less than 20 wt. % of at least one semi-crystalline partially fluorinated polymer [polymer (F)] comprising recurring units derived from 1,1-difluoroethylene (VDF);
from 2 wt. % to less than 40 wt. % of at least one liquid medium [medium (L)] characterized by a boiling point higher than 100° C., wherein said medium (L) may optionally further comprise at least one metal salt [salt (M)];
at least 50 wt. % of at least one electro-active compound [compound (EA)];
optionally, a polymer [polymer (P)] comprising a backbone complying with the following formula:
—[(CH₂)ₓ—CHR¹—R²)—
wherein
x is in integer from 1 to 3,
R¹ is hydrogen or methyl group; and
R² is oxygen atom or a group of formula —OC(═O)R³ with R³ being hydrogen atom or methyl,
wherein the above amounts are based on the total weight of said composition (C).

12. The assembly according to claim 10 that comprises:
at least one surface-modified metal foil (M), and
directly adhered onto at least part of both the two sides of said surface-modified metal foil (M), at least one layer (L1) consisting of a composition (C) comprising:
from 0.5 wt. % to less than 20 wt. % of at least one semi-crystalline partially fluorinated polymer [polymer (F)] comprising recurring units derived from 1,1-difluoroethylene (VDF);
from 2 wt. % to less than 40 wt. % of at least one liquid medium [medium (L)] characterized by a boiling point higher than 100° C., wherein said medium (L) may optionally further comprise at least one metal salt [salt (M)];
at least 50 wt. % of at least one electro-active compound [compound (EA)];
optionally, a polymer [polymer (P)] comprising a backbone complying with the following formula:
—[(CH₂)ₓ—CHR¹—R²)—
wherein
x is in integer from 1 to 3,
R¹ is hydrogen or methyl group; and
R² is oxygen atom or a group of formula —OC(═O)R³ with R³ being hydrogen atom or methyl,
wherein the above amounts are based on the total weight of said composition (C).

13. The assembly according to claim 10, that is an electrode [electrode (E)].

14. A secondary battery comprising:
a positive electrode,
a negative electrode, and
between said positive electrode and said negative electrode, a membrane,
wherein at least one of the positive electrode and the negative electrode is the electrode (E) of claim 13.

15. The process according to claim 1, wherein composition (C) comprises less than 15 wt % of polymer (F).

16. The process according to claim 1, wherein the boiling point is higher than 150° C.

17. The process according to claim 5, wherein the polymer (F) comprises:
at least 90% by moles of recurring units derived from VDF,
from 0.1% to 1.5% by moles of recurring units derived from at least one hydrogenated monomer comprising at least one carboxylic acid end group [monomer (MA)],
from 6% to 10% by moles of at least one partially or fully fluorinated monomer [monomer (F_{FH})], said monomer (F_{FH}) being different from VDF.

18. The process according to claim 5, wherein the polymer (F) consists of:
at least 90% by moles of recurring units derived from VDF,
from 0.1% to 1.5% by moles of recurring units derived from at least one hydrogenated monomer comprising at least one carboxylic acid end group [monomer (MA)],
from 6% to 10% by moles of at least one partially or fully fluorinated monomer [monomer (F_{FH})], said monomer (F_{FH}) being different from VDF.
